(19) United States
(12) Patent Application Publication
(10) Pub. No.: US 2013/0182118 A1
(43) Pub. Date: Jul. 18, 2013

(54) Method For Performing Video Surveillance Of A Mobile Unit

(71) Applicants: Tim J. Olker, Warrenville, IL (US); Leslie J. Williams, Naperville, IL (US)

(72) Inventors: Tim J. Olker, Warrenville, IL (US); Leslie J. Williams, Naperville, IL (US)

(21) Appl. No.: 13/350,319

(22) Filed: Jan. 13, 2012

(51) Int. Cl. H04N 7/18

(52) U.S. Cl. 348/158; 348/E07.085

(57) ABSTRACT

A method for performing video surveillance of a mobile unit in a wireless network is provided. A wireless network receives a surveillance request for a mobile unit. The surveillance request comes from a law enforcement agency and includes the identity of the mobile unit and a geographical area. The wireless network determines that the mobile unit has entered the geographical area and sends the geographical location of the mobile unit from the wireless network to the law enforcement agency.

### FIELD OF THE INVENTION

The present invention relates generally to communication systems, and more particularly to surveillance of mobile units.

### BACKGROUND OF THE INVENTION

Currently law enforcement agencies receive location information about targets, and must manually identify where the target is and need to contact various branches of law enforcement that possess aircraft to perform surveillance. This process is very slow and requires many manual steps, which slows the progress down even more.

In addition, by the time the appropriate contacts have been made the target has often moved from the identified location. In this scenario, the target must be manually identified again, and the entire lengthy process of obtaining approval, tracking the target, and requesting and obtaining aircraft surveillance must be recompleted.

Therefore, a need exists for a way of obtaining video surveillance of a target without the delays and problems associated with the current state of the art.

### BRIEF SUMMARY OF THE INVENTION

An exemplary embodiment of the present invention relates to a method and system for performing video surveillance of a mobile unit.

In accordance with an exemplary embodiment, a court order is entered at a law enforcement agency (LEA). The court order indicates that an action of visual surveillance is requested, which includes the target mobile device and a priority level for the surveillance.

The LEA sends a request surveillance message to the wireless network, which provides service to the targeted mobile unit. The request surveillance message preferably includes a request for visual surveillance of the targeted mobile unit, the identity of the targeted mobile unit, and the priority level for the surveillance.

At some point a user utilizes the targeted mobile unit. For example, the user can initiate a call, receive a call, send or receive a text message, update the status of the mobile unit, or any other message that the mobile unit sends to the wireless network. At this point the targeted mobile unit sends an update message to the wireless network. In an exemplary embodiment, the update message includes an IRI that includes location information of the targeted mobile unit.

The wireless network sends a location information message to the LEA. The LEA identifies that the targeted mobile unit is requested to have visual surveillance. The LEA can also include other information in making this decision, including but not limited to whether the mobile device is within a set of geographic areas or the time of day. Upon determining that the test for requesting visual surveillance is met, the LEA evaluates a group of assets near the location of the mobile unit that can respond to the request.

In accordance with an exemplary embodiment, the LEA sends a query message to a UAV flight controller, which preferably controls at least one unmanned aerial vehicle (UAV) that covers the requested location. The UAV flight controller preferably utilizes the requested location and the priority information to determine whether it can deploy a UAV for surveillance.

If the UAV flight controller is able to deploy a UAV in the region that includes the location of the targeted mobile unit, the UAV flight controller deploys a UAV. The UAV may already be airborne or could be currently grounded but prepared to fly.

The LEA then preferably sends a surveillance request message to the UAV flight controller to observe the specified geographical coordinates reported in the request.

The UAV flight controller forwards surveillance the request message to the UAV. The UAV maneuvers into position to observe the specified geographical coordinates. In an exemplary embodiment, the specified geographical coordinates include the current location of the targeted mobile unit.

When at the specified geographical coordinates, the UAV performs the requested action. In an exemplary embodiment, the requested action is to perform video surveillance of the requested mobile device.

The UAV sends recorded video to the UAV flight controller.

The UAV flight controller forwards the surveillance video to the LEA, which then preferably makes the surveillance video available to law enforcement agents.

At some point the targeted mobile unit may change locations and no longer be located within the specified geographical coordinates.

In accordance with an exemplary embodiment, the wireless network reports the new location of the targeted mobile device to the LEA by sending a new location message to the LEA. The new location message includes the new geographical coordinates of the targeted mobile unit.

Since in this exemplary embodiment the LEA already has the UAV allocated to it, the LEA passes the updated location information to the UAV flight controller within an updated location message.

The UAV flight controller forwards the new location of the targeted mobile unit to the UAV in a new location message. In response to receipt of the new location message, the UAV maneuvers into a position to monitor the targeted mobile unit.

The UAV proceeds to monitor the new location and provide updated video information to the UAV flight controller of the new location.

The UAV flight controller forwards the newly received video to the LEA, which then makes the video available to law enforcement agents.

When a predefined condition is met, the LEA sends a release message to the UAV to release the UAV from surveillance and make the UAV available for surveillance on other targets. In accordance with an exemplary embodiment, the predefined condition is a time duration. Alternately, the predefined condition can be that the target has left a geographic area, that the target hasn't moved for a specified amount of time or an LEA operator manually triggers the release. In the embodiment where the duration of the surveillance is extended, the UAV flight controller preferably requests that a second UAV position itself over the target geographical location before releasing the first UAV to return for refueling or other purposes.

### BRIEF DESCRIPTION OF THE SEVERAL VIEWS OF THE DRAWINGS

FIG. 1 depict a wireless network in accordance with an exemplary embodiment of the present invention.

FIG. 2 depicts a flow diagram in accordance with an exemplary embodiment of the present invention.

### DETAILED DESCRIPTION OF THE INVENTION

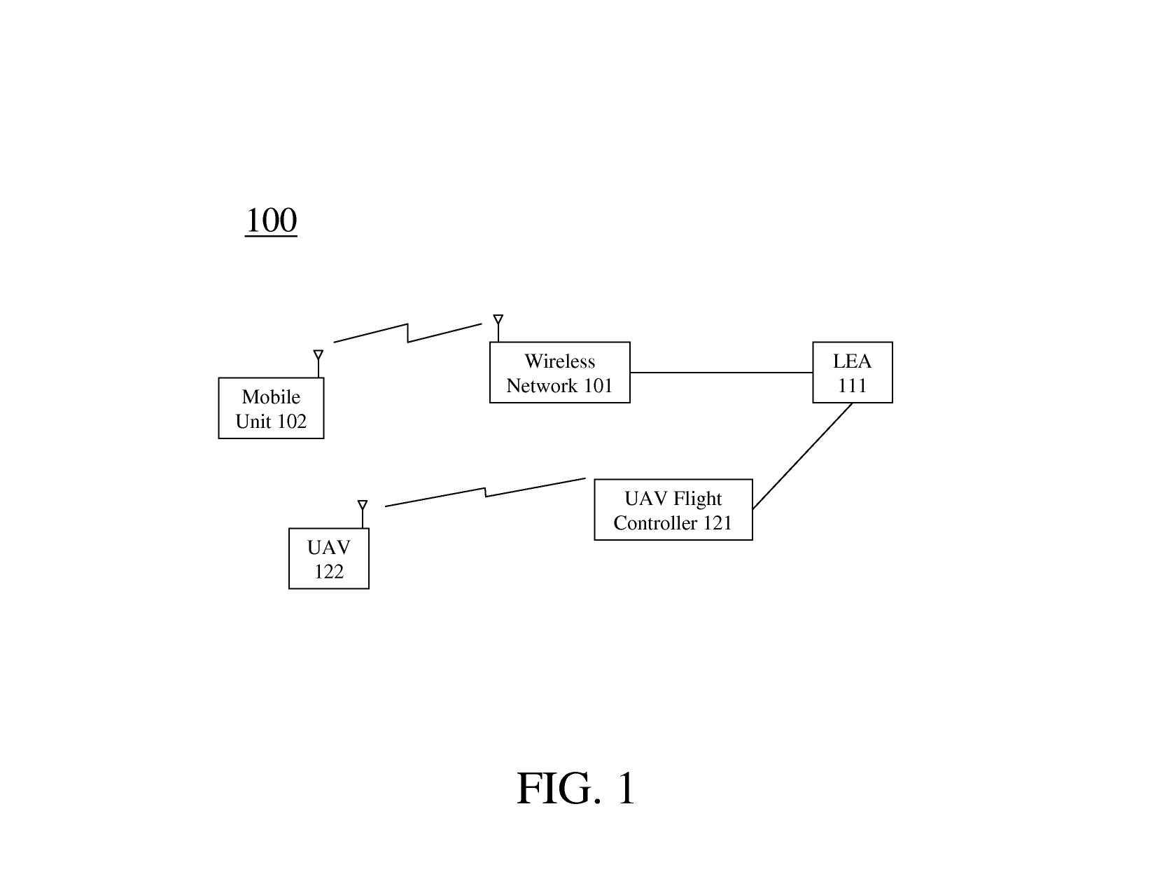

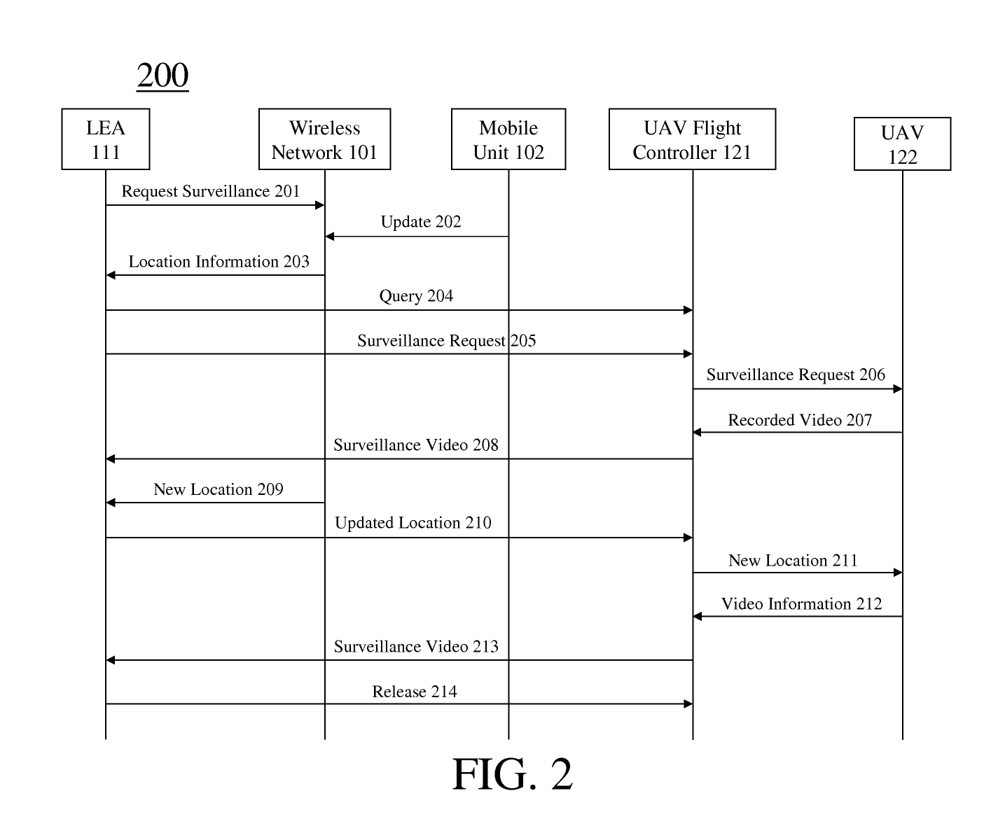

An exemplary embodiment of the present invention can be better understood with reference to FIGS. 1 and 2. FIG. 1 depicts a communication network 100 including a wireless network 101, mobile unit 102, law enforcement agency 111, UAV flight controller 121, and UAV 122.

In accordance with an exemplary embodiment, wireless network 101 comprises a plurality of base stations and other network elements that allow wireless network 101 to process wireless communications. Wireless network 101 communicates with mobile unit 102 via any of a plurality of air interfaces.

Mobile unit 102 is a mobile device that communicates with wireless network 101, preferably using a wireless air interface.

Law enforcement agency (LEA) 111 is an agency that is legally authorized to perform surveillance activities. For example, LEA 111 can be the Federal Bureau of Investigation (FBI), state police departments, or local police departments.

Unmanned aerial vehicle (UAV) 122 is an unmanned aircraft that functions either by remote control or as a self-directing entity. UAV 122 is a powered, aerial vehicle that does not carry a human operator, uses aerodynamic forces to provide vehicle lift, can fly autonomously or be piloted remotely, can be expendable or recoverable, and carries a video surveillance system. UAV 122 can be a drone, which is a remotely controlled aircraft. UAV 122 can be controlled from a remote location or can be flown autonomously based on pre-programmed flight plans including a defined geographical area. It should be understood that the present invention can utilize any remote sensing device, such as stationary video cameras, regular cameras, people in the area, parabolic dishes to listen in to conversations, helicopters, satellites, patrol cars, etc.

UAV flight controller 121 is a controller or other computing device that provides instructions and control to UAV 122. UAV flight controller 121 is preferably located apart from UAV 122 and provides instructions and control from a remote location.

FIG. 2 depicts a flow diagram 200 in accordance with an exemplary embodiment of the present invention. In accordance with an exemplary embodiment, a court order is entered at LEA 111. The court order indicates that an action of visual surveillance is requested, which includes the target mobile device and a priority level for the surveillance.

The LEA sends a request surveillance message 201 to wireless network 101, which provides service to mobile unit 102. The request surveillance message 201 preferably includes a request for visual surveillance of mobile unit 102, the identity of the requested mobile unit 102, and the priority level for the surveillance.

At some point a user utilizes mobile unit 102. For example, the user can initiate a call, receive a call, send or receive a text message, update the status of mobile unit 102, or any other message that mobile unit 102 sends to wireless network 101. At this point mobile unit 102 sends update message 202 to wireless network 101. In an exemplary embodiment, update message 202 includes an IRI that includes location information of mobile unit 102.

Wireless network 101 sends location information message 203 to LEA 111.

LEA 111 identifies that the target is requested to have visual surveillance. LEA 111 can also include other information in making this decision, including but not limited to whether the mobile device is within a set of geographic areas or the time of day. Upon determining that the test for requesting visual surveillance is met, LEA 111 evaluates a group of assets near the location of mobile unit 102 that can respond to the request.

In accordance with an exemplary embodiment, LEA 111 sends query message 204 to UAV flight controller 121. UAV flight controller 121 controls at least one UAV 122 that covers the requested location. UAV flight controller 121 preferably utilizes the requested location and the priority information to determine whether it can deploy a UAV for surveillance.

If UAV flight controller 121 is able to deploy a UAV in the region that includes the location of mobile unit 102, UAV flight controller 121 deploys UAV 122. UAV 122 may already be airborne or could be currently grounded but prepared to fly.

LEA 111 then preferably sends surveillance request message 205 to UAV flight controller 121 to observe the specified geographical coordinates reported in the request.

UAV flight controller 121 forwards surveillance request message 206 to UAV 122. UAV 122 maneuvers into position to observe the specified geographical coordinates. In an exemplary embodiment, the specified geographical coordinates include the current location of mobile unit 102.

When at the specified geographical coordinates, UAV 122 performs the requested action. In an exemplary embodiment, the requested action is to perform video surveillance of the requested mobile device.

UAV 122 sends recorded video 207 to the UAV flight controller.

UAV flight controller 121 forwards surveillance video 208 to LEA 111, which then preferably makes the surveillance video available to law enforcement agents.

At some point mobile unit 102 may change locations and no longer be located within the specified geographical coordinates.

In accordance with an exemplary embodiment, wireless network 101 reports the new location of the mobile device to LEA 111 by sending new location message 209 to LEA 111. New location message 209 includes the new geographical coordinates of mobile unit 102.

Since in this exemplary embodiment LEA 111 already has UAV 122 allocated to it, LEA 111 passes the updated location information to UAV flight controller 121 within updated location message 210.

UAV flight controller 121 forwards the new location of mobile unit 102 to UAV 122 in new location message 211. In response to receipt of new location message 211, UAV 122 maneuvers into a position to monitor mobile unit 102.

UAV 122 proceeds to monitor the new location and provide updated video information 212 to UAV flight controller 121 of the new location.

UAV flight controller 121 forwards the newly received video 213 to LEA 111, which then makes the video available to law enforcement agents.

When a predefined condition is met, LEA 111 sends release message 214 to UAV 122 to release UAV 122 from surveillance and make UAV 122 available for surveillance on other targets. In accordance with an exemplary embodiment, the predefined condition is a time duration. Alternately, the predefined condition can be that the target has left a geographic area, that the target hasn't moved for a specified amount of time or an LEA operator manually triggers the release. In the embodiment where the duration of the surveillance is extended, UAV flight controller 121 preferably requests that a second UAV position itself over the target geographical location before releasing the first UAV to return for refueling or other purposes.

While this invention has been described in terms of certain examples thereof, it is not intended that it be limited to the above description, but rather only to the extent set forth in the claims that follow.

We claim:

1. A method for performing video surveillance of a mobile unit in a wireless network, comprising:
receiving a surveillance request for a mobile unit at the wireless network from a law enforcement agency, the surveillance request including the identity of the mobile unit and a geographical area;
determining at the wireless network that the mobile unit has entered the geographical area; and
sending the geographical location from the wireless network to the law enforcement agency.

2. A method for performing video surveillance of a mobile unit in a wireless network in accordance with claim 1, wherein the surveillance request comprises a request for visual surveillance.

3. A method for performing video surveillance of a mobile unit in a wireless network in accordance with claim 1, wherein the surveillance request comprises a priority level.

4. A method for performing video surveillance of a mobile unit in a wireless network in accordance with claim 1, wherein the surveillance request comprises a time of day in which the surveillance should occur.

5. A method for performing video surveillance of a mobile unit in a wireless network in accordance with claim 1, wherein the step of determining that the mobile unit has entered the geographical area comprises determining that the mobile unit has initiated a call.

6. A method for performing video surveillance of a mobile unit in a wireless network in accordance with claim 1, wherein the step of determining that the mobile unit has entered the geographical area comprises determining that the mobile unit has received a call.

7. A method for performing video surveillance of a mobile unit in a wireless network in accordance with claim 1, wherein the step of determining that the mobile unit has entered the geographical area comprises determining that the mobile unit has sent a text message.

8. A method for performing video surveillance of a mobile unit in a wireless network in accordance with claim 1, wherein the step of determining that the mobile unit has entered the geographical area comprises determining that the mobile unit has received a text message.

9. A method for performing video surveillance of a mobile unit in a wireless network in accordance with claim 1, wherein the step of determining that the mobile unit has entered the geographical area comprises determining that the mobile unit has updated the status of the mobile unit.

10. A method for performing video surveillance of a mobile unit in a wireless network in accordance with claim 1, the method further comprising determining that the mobile unit has left the geographical area.

11. A method for performing video surveillance of a mobile unit in a wireless network in accordance with claim 10, the method further comprising reporting to the law enforcement agency that the mobile unit is no longer located within the geographical area.

12. A method for performing video surveillance of a mobile unit in a wireless network in accordance with claim 10, further comprising sending the new geographical location from the wireless network to the law enforcement agency.

13. A method for performing video surveillance of a mobile unit in a wireless network in accordance with claim 12, wherein the step of sending the new geographical location comprises sending the new geographical coordinates of the mobile unit.
